(19) United States
(12) Patent Application Publication
(10) Pub. No.: US 2023/0395842 A1
(43) Pub. Date: Dec. 7, 2023

(54) SOLID-STATE BATTERY

(71) Applicant: LIVENT LITHIUM LLC, Philadelphia, PA (US)

(72) Inventors: Jian Xia, Belmont, NC (US); Rebecca Black, Charlotte, NC (US); Anantharamulu Navulla, Cary, NC (US); Marina Yakovleva, Gastonia, NC (US); Kenneth Brian Fitch, Cherryville, NC (US)

(21) Appl. No.: 18/205,712

(22) Filed: Jun. 5, 2023

Related U.S. Application Data
(60) Provisional application No. 63/349,742, filed on Jun. 7, 2022.
(60) Provisional application No. 63/430,206, filed on Dec. 5, 2022.

(51) Int. Cl. H01M 10/056; H01M 4/62; H01M 4/04; H01M 10/0525; H01M 4/134

(52) U.S. Cl. CPC H01M 10/056; H01M 4/62; H01M 4/0404; H01M 10/0525; H01M 4/134; H01M 2300/0065

(57) ABSTRACT

The present invention provides a solid-state battery which includes a cathode, an anode, and a hybrid solid electrolyte. In one embodiment, the anode or cathode may be conventional anodes or cathodes, or the anode may be formed by printing a printable lithium composition being on a solution basis of a) 5 to 50 percent of lithium metal powder, b) 0.1 to 20 of a polymer binder compatible with the lithium metal powder, and c) 0.1 to 30 percent of a rheology modifier compatible with the lithium metal powder, and d) 50 to 95 percent of a nonpolar solvent compatible with the lithium metal powder and with the polymer binder.

The hybrid solid electrolyte may be a lithium-based solid electrolyte material comprising Li₃₊ₓ Aₓ B₂₋ₓ Si₂ PO_{12-d} C_{d} wherein A is a trivalent metal, B is a transition metal, C is a halogen or sulfur, x is 0.01 to 0.5, and d is 0 to 12, a polymer solid electrolyte and an inorganic salt. The hybrid solid electrolyte may also be the combination of polyethylene oxide, tantalum-doped lithium lanthanum zirconate (LLTZO) and lithium bis(trifluoromethanesulfonyl) imide (LiTSFI).

### RELATED APPLICATIONS

The following non-provisional utility application claims priority to U.S. Provisional No. 63/349,742 filed Jun. 7, 2022, and U.S. Provisional No. 63/430,206 filed Dec. 2022, the disclosures of which are incorporated by reference in their entireties.

### FIELD OF THE INVENTION

The present invention relates to a solid-state battery which includes a printable lithium composition and a hybrid solid electrolyte (HSE)

### BACKGROUND OF THE INVENTION

Lithium and lithium-ion secondary or rechargeable batteries have found use in certain applications such as in cellular phones, camcorders, and laptop computers, and even more recently, in larger power application such as in electric vehicles, hybrid electric vehicles and eVTOL and other air mobility applications. It is preferred in these applications that the secondary batteries have the highest specific capacity possible but still provide safe operating conditions and good cyclability so that the high specific capacity is maintained in subsequent recharging and discharging cycles.

Although there are various constructions for secondary batteries, each construction includes a positive electrode (or cathode), a negative electrode (or anode), a separator that separates the cathode and anode, an electrolyte in electrochemical communication with the cathode and anode. For secondary lithium batteries, lithium ions are transferred from the anode to the cathode through the electrolyte when the secondary battery is being discharged, i.e., used for its specific application. During the discharge process, electrons are collected from the anode and pass to the cathode through an external circuit. When the secondary battery is being charged, or recharged, the lithium ions are transferred from the cathode to the anode through the electrolyte.

Historically, secondary lithium batteries were produced using non-lithiated compounds having high specific capacities such as TiS₂, MoS₂, MnO2, and V₂O₅, as the cathode active materials. These cathode active materials were coupled with a lithium metal anode. When the secondary battery was discharged, lithium ions were transferred from the lithium metal anode to the cathode through the electrolyte. Unfortunately, upon cycling, the lithium metal developed dendrites that ultimately caused unsafe conditions in the battery. As a result, the production of these types of secondary batteries was stopped in the early 1990s in favor of lithium-ion batteries.

Lithium-ion batteries typically use lithium metal oxides such as LiCoO₂ and LiNiO₂ as cathode active materials coupled with an active anode material such as a carbon-based material. It is recognized that there are other anode types based on silicon oxide, silicon particles and the like. In batteries utilizing carbon-based anode systems, the lithium dendrite formation on the anode is substantially avoided, thereby making the battery safer. However, the lithium, the amount of which determines the battery capacity, is totally supplied from the cathode. This limits the choice of cathode active materials because the active materials must contain removable lithium. Also, delithiated products corresponding to LixCoO₂, LixNiO₂ formed during charging and overcharging are not stable. In particular, these delithiated products tend to react with the electrolyte and generate heat, which raises safety concerns.

New lithium-ion cells or batteries are initially in a discharged state. During the first charge of lithium-ion cell, lithium moves from the cathode material to the anode active material. The lithium moving from the cathode to the anode reacts with an electrolyte material at the surface of the graphite anode, causing the formation of a passivation film on the anode. The passivation film formed on the graphite anode is a solid electrolyte interface (SEI). Upon subsequent discharge, the lithium consumed by the formation of the SEI is not returned to the cathode. This results in a lithium-ion cell having a smaller capacity compared to the initial charge capacity because some of the lithium has been consumed by the formation of the SEI. The partial consumption of the available lithium on the first cycle reduces the capacity of the lithium-ion cell. This phenomenon is called irreversible capacity and is known to consume about 10% to more than 20% of the capacity of a lithium ion cell. Thus, after the initial charge of a lithium-ion cell, the lithium-ion cell loses about 10% to more than 20% of its capacity.

One solution has been to use stabilized lithium metal powder to pre-lithiate the anode. For example, lithium powder can be stabilized by passivating the metal powder surface with carbon dioxide such as described in U.S. Pat. Nos. 5,567,474, 5,776,369, and 5,976,403, the disclosures of which are incorporated herein in their entireties by reference. The CO₂-passivated lithium metal powder can be used only in air with low moisture levels for a limited period of time before the lithium metal content decays because of the reaction of the lithium metal and ambient air. Another solution is to apply a coating such as fluorine, wax, phosphorus or a polymer to the lithium metal powder such as described in U.S. Pat. Nos. 7,588,623, 8,021,496, 8,377,236 and U.S. Patent Publication No. 2017/0149052, for example.

There, however, remains a need for a solid-state battery having lithiated or prelithiated components for increased energy density and improved safety and manufacturability.

### SUMMARY OF THE INVENTION

To this end, the present invention provides a solid-state battery which includes a cathode, an anode, and a hybrid solid electrolyte. In one embodiment, the anode or cathode may be conventional anodes or cathodes. In another embodiment, the anode may be formed by printing a printable lithium composition comprised on a solution basis of a) 5 to 50 percent of lithium metal powder, b) 0.1 to 20 of a polymer binder compatible with the lithium metal powder, and c) 0.1 to 30 percent of a rheology modifier compatible with the lithium metal powder, and d) 50 to 95 percent of a nonpolar solvent compatible with the lithium metal powder and with the polymer binder. In another embodiment, a dry, solvent free process may be used to form the anode.

In one embodiment, the hybrid solid electrolyte may comprise a lithium-based solid electrolyte material comprising Li₃₊ₓ Aₓ B₂₋ₓ Si₂ PO_{12-d} C_{d} wherein A is a trivalent metal, B is a transition metal, C is a halogen or sulfur, x is 0.01 to 0.5, and d is 0 to 12, a polymer solid electrolyte and an inorganic salt.

In another embodiment, the hybrid solid electrolyte may include the combination of polyethylene oxide, tantalum-doped lithium lanthanum zirconate (LLTZO) and lithium bis(trifluoromethanesulfonyl) imide (LiTSFI).

A solid-state battery comprising the printable lithium composition and a hybrid solid electrolyte may have increased energy density and improved safety and manufacturability.

### BRIEF DESCRIPTION OF THE DRAWINGS

FIG. 1 is a schematic of a solid-state battery according to one embodiment of the present invention and

FIG. 2 is a plot showing the cycle performance for an Example 1 coin cells according to the present invention as compared to the prior art of a coin cell made with a conventional anode having a 20 μm or 250 μm thickness conventionally available lithium foil.

FIG. 3 is a plot showing the cycle performance for an Example 2 coin cell according to the present invention as compared to a coin cell made with a conventional anode having a 250 μm thickness conventionally available lithium foil.

FIG. 4 is a plot showing the cycle performance for an Example 3 coin cell according to the present invention as compared to a coin cell made with a conventional anode having a thickness of either 20 μm or 250 μm commercial lithium foil.

### DETAILED DESCRIPTION OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

The term “about,” as used herein when referring to a measurable value such as an amount of a compound, dose, time, temperature, and the like, is meant to encompass variations of 20%, 10%, 5%, 1%, 0.5% or even 0.1% of the specified amount. Unless otherwise defined, all terms, including technical and scientific terms used in the description, have the same meaning as commonly understood by one of ordinary skill in the art to which this invention belongs.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

As used herein, the term “consists essentially of” (and grammatical variants thereof), as applied to the compositions and methods of the present invention, means that the compositions/methods may contain additional components so long as the additional components do not materially alter the composition/method. The term “materially alter,” as applied to a composition/method, refers to an increase or decrease in the effectiveness of the composition/method of at least about 20% or more.

All patents, patent applications and publications referred to herein are incorporated by reference in their entirety. In case of a conflict in terminology, the present specification is controlling.

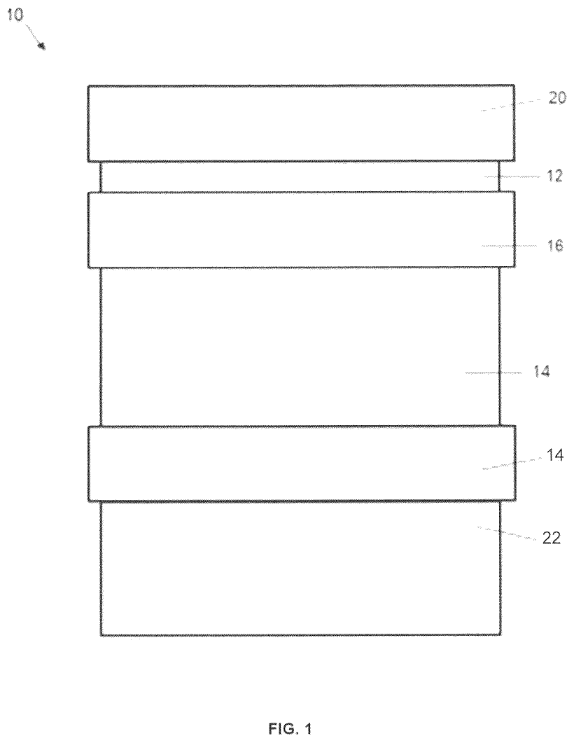

Referring now to FIG. 1, a solid-state battery 10 comprising an anode 12, a cathode 14 and a solid electrolyte 16 is provided in accordance with one embodiment of the present invention. The solid-state battery may further include an anode current collector 20 and a cathode current collector 22. A printable lithium composition may be applied or deposited to a current collector, electrode and/or solid electrolyte of the solid-state battery. For example, the printable lithium composition may be used to form a monolithic lithium metal anode of various thicknesses and widths for use in a solid-state battery, including solid-state batteries as described in U.S. Pat. Nos. 8,252,438 and 9,893,379 and incorporated herein by reference in their entireties.

The electrolyte may be a solid electrolyte, and more particularly a hybrid solid electrolyte (HSE). In one embodiment, the hybrid solid electrolyte may have a NASICON-type crystal structure and may have either a rhombohedral or monoclinic structure. Lithium provides advantages over sodium in that lithium has the lowest standard reduction potential (−3.07 v) which results in a high cell nominal voltage. Additionally, lithium-based anodes and cathodes will form more stable and reversible batteries as compared to sodium-based compounds.

Specifically, the lithium-based solid electrolyte may comprise Li₃₊ₓ Aₓ B₂₋ₓ Si₂ PO_{12-d} C_{d} wherein A is a trivalent metal, B is a transition metal, C is a halogen or sulfur, x is 0.01 to 0.5, and d is 0 to 12. The trivalent metal may be selected from the group consisting of Sc, Y, La, Cr, Al, Fe, V, Cr, In, Ga, and Lu. The transition metal may be selected from the group consisting of Ti, Ge, Ta, Zr, Sn, Fe, V. Hf, Nb, Sb and As. Exemplary halogens may include chlorine, fluorine, bromine, and iodine when d is greater than 0, and d may be 0.05 to 0.1.

Specific lithium-based solid electrolyte materials are described in U.S. Application No. ______ (Attorney Docket No. 073396.1463) filed concurrently herewith on June ______, 2023 and may include Li_{3.4}Zr_{1.6}Sc_{0.4}Si₂PO₁₂, Li_{3.25}Zr_{1.75}Sc_{0.25}Si₂PO₁₂, Li_{3.4}Zr_{1.6}Sc_{0.4}Si₂PO_{11.95}Cl_{0.05}, Li_{3.4}Zr_{1.6}Sc_{0.4}Si₂PO_{11.9}Cl_{0.1}, Li_{3.25}Zr_{1.75}Sc_{0.25}Si₂PO_{11.95}Cl_{0.05}, and Li_{3.25}Zr_{1.75}Sc_{0.25}Si₂PO_{11.9}Cl_{0.1} and Li_{3.1}Zr_{1.9}Sc_{0.1}SiPO₁₂.

In another embodiment, the solid electrolyte may include the tantalum-doped lithium lanthanum zirconate (LLTZO), Li₁₊ₓAIₓTi₂₋ₓ(PO₄)₃ (LATP), and Li₁₊ₓAlGe₂₋ₓ(PO₄)₃ (LAGP), described, for example, in “Recent Developments and Challenges in Hybrid Solid Electrolytes for Lithium Ion Batteries” Han et al, Frontiers in Energy Research. September 2020, Vol. 5., pp 1-19, and in U.S. Publication No. 2020/0185758, the disclosure of which are incorporated herein by reference in their entireties.

In one embodiment, the solid electrolyte may be a hybrid solid electrolyte and include one of the above lithium-based solid electrolyte materials, a polymer solid electrolyte and an inorganic salt. Exemplary polymer solid electrolytes may include polyethylene oxide (PEO), polysiloxane (PSO), polypropylene carbonate (PPC), polyethylene carbonate (PEC), polyvinyl chloride (PVC), polyacrylonitrile (PAN), polyacrylic acid (PAA), polyvinylidene fluoride or polyvinylidene difluoride (PVDF), poly(vinylidene fluoride-co-hexafluoropropylene) (PVDF-HFP), polymethyl methacrylate (PMMA), n-hydroxysuccinimide (NHD), polypropylene glycol (PPG), polydimethylsiloxane (PDMS), polypropylene carbonate (PPC), polycaprolactone (PCL), polytrimethylene carbonate (PTMC) and polyethylenimine (PEI) or a polymeric ionic liquid (PIL). Exemplary inorganic salts may include lithium bis(trifluoromethanesulfonyl)imide (LiTFSI), lithium bis(fluorosulfonyl)imide (LiFSI), lithium hexafluorophosphate (LiPF₆), lithium perchlorate (LiCLO₄), lithium tetrafluoroborate (LiBF₄), lithium sulfate (Li₂SO₄), trifluoromethyl radical (CF₃), lithium hexafluoroarsenate (LiAsF₆), lithium bis(oxalate)borate (LiBOB) and lithium difluoro(oxalate)borate (LiDFOB).

In another embodiment, in place of PEO, other polymeric ionic liquids (poly(ethylene glycol) diacrylate based ionic liquids or similar) or ionic liquids having a high melting point may be used and include ionic liquids such as butylmethylimidazolium (BMIM), ethylmethylimidazolium (ENIM) and dimethylimidazolium (DMIM) units or similar.

In yet another embodiment, the LLZTO portion of the HSE may also be doped or replaced with an anion (oxygen) site doped garnet or Nasicon (sodium super ionic conductor) type solid electrolytes. Here the doping elements could be chlorine, fluorine, or sulfur to improve the grain boundary conductivity and decrease the interfacial resistance thereby improving cell performance.

A printable lithium composition may be used to provide the anode by applying the composition by various methods, including extruding, coating, printing, painting, dipping, and spraying as disclosed in U.S. application Ser. No. 16/359,707. As disclosed in U.S. application Ser. No. 17/324,499, the printable lithium composition comprises a lithium metal powder, a polymer binder, a rheology modifier and may further include a solvent. A commercially available printable lithium composition is available as Liovix® from Livent USA Corp. The polymer binder may be compatible with the lithium metal powder. The rheology modifier may be compatible with the lithium metal powder and the polymer binder. The solvent may be compatible with the lithium metal powder and with the polymer binder. The lithium metal powder may be in the form of a finely divided powder. The lithium metal powder typically has a mean particle size of less than about microns, often less than about 40 microns and sometimes less than about 20 microns. The lithium metal powder may be a low pyrophoricity stabilized lithium metal powder (SLMP®) available from Livent USA Corp. The lithium metal powder may also include a substantially continuous layer or coating of fluorine, wax, phosphorus, a polymer, or the combination thereof (as disclosed in U.S. Pat. Nos. 5,567,474, and 5,976,403). Lithium metal powder has a significantly reduced reaction with moisture and ambient air. The anode may be lithiated or prelithiated by printing the printable lithium composition onto the anode or a current collector, where the thin lithium film with controlled thickness and width could be formed, or coating the anode with the printable lithium composition.

In one embodiment, the printable lithium composition may be used to pre-lithiate an anode as described in U.S. Pat. No. 9,837,659 herein incorporated by reference in its entirety. For example, the method includes disposing a layer of printable lithium composition adjacent to a surface of a pre-fabricated/pre-formed anode. The pre-fabricated electrode comprises an electroactive material. In certain variations, the printable lithium composition may be applied to the carrier/substrate via a deposition process. A carrier substrate on which the layer of printable lithium composition may be disposed may be selected from the group consisting of: polymer films (e.g., polystyrene, polyethylene, polyethyleneoxide, polyester, polypropylene, polypolytetrafluoroethylene), ceramic films, copper foil, nickel foil, or metal foams and mesh by way of non-limiting example. Heat may then be applied to the printable lithium composition layer on the substrate or the pre-fabricated anode. The printable lithium composition layer on the substrate or the pre-fabricated anode may be further compressed together, under applied pressure. The heating, and optional applied pressure, facilitates transfer of lithium onto the surface of the substrate or anode. In case of transfer to the pre-fabricated anode, pressure and heat can result in mechanical lithiation, especially where the pre-fabricated anode comprises graphite. In this manner, lithium transfers to the electrode and due to favorable thermodynamics is incorporated into the active material.

In another embodiment, the anode may be formed by dry mixing the printable lithium composition such as described in U.S. application Ser. No. 17/702,154. Dry mixing is intended to mean that essentially or substantially no solvent or an essentially or substantially low amount of solvent is used in the mixing process. In one embodiment, the only solvent present is from the prelithiation agent.

The dry electrode material mixture may then be applied to a substrate to form the electrode as a non-self-supporting layer or interface. A non-self-supporting layer or interface is a layer or interface or coating that cannot standalone and is in contrast to a standalone film or foil.

The polymer binder is selected so as to be compatible with the lithium metal powder. “Compatible with” or “compatibility” is intended to convey that the polymer binder does not violently react with the lithium metal powder resulting in a safety hazard. The lithium metal powder and the polymer binder may react to form a lithium-polymer complex, however, such complex should be stable at various temperatures. It is recognized that the amount (concentration) of lithium and polymer binder contribute to the stability and reactivity. The polymer binder may have a molecular weight of about 1,000 to about 8,000,000, and often has a molecular weight of 2,000,000 to 5,000,000. Suitable polymer binders may include one or more of poly(ethylene oxide), polystyrene, polyisobutylene, natural rubbers, butadiene rubbers, styrene-butadiene rubber, polyisoprene rubbers, butyl rubbers, hydrogenated nitrile butadiene rubbers, epichlorohydrin rubbers, acrylate rubbers, silicon rubbers, nitrile rubbers, polyacrylic acid, polyvinylidene chloride, polyvinyl acetate, ethylene propylene diene termonomer, ethylene vinyl acetate copolymer, ethylene-propylene copolymers, ethylene-propylene terpolymers, polybutenes. The binder may also be a wax. In one embodiment, the binder is added as a dry powder

The rheology modifier is selected to be compatible with the lithium metal powder and the polymer binder. The rheology modifier provides rheology properties such as viscosity. The rheology modifier may also provide conductivity, improved capacity and/or improved stability/safety depending on the selection of the rheology modifier. To this end, the rheology modifier may be the combination of two or more compounds so as to provide different properties or to provide additive properties. Exemplary rheology modifiers may include one or more of carbon black, carbon nanotubes, graphene, silicon nanotubes, graphite, hard carbon and mixtures, fumed silica, titanium dioxide, zirconium dioxide and other Group IIA, IIIA, IVB, VB and VIA elements/compounds and mixtures or blends thereof.

Solvents compatible with lithium may include acyclic hydrocarbons, cyclic hydrocarbons, aromatic hydrocarbons, symmetrical ethers, unsymmetrical ethers, cyclic ethers, alkanes, sulfones, mineral oil, and mixtures, blends or cosolvents thereof. Examples of suitable acyclic and cyclic hydrocarbons include n-hexane, n-heptane, cyclohexane, and the like. Examples of suitable aromatic hydrocarbons include toluene, ethylbenzene, xylene, isopropylbenzene (cumene), and the like. Examples of suitable symmetrical, unsymmetrical and cyclic ethers include di-n-butyl ether, methyl t-butyl ether, tetrahydrofuran, glymes and the like. Commercially available isoparaffinic synthetic hydrocarbon solvents with tailored boiling point ranges such as Shell Sol® (Shell Chemicals) or Isopar® (Exxon) are also suitable.

The binder and solvent should be compatible with each other at the temperatures at which the printable lithium composition is made and will be used. In one embodiment, the solvent is low in hygroscopicity in that there is a minimum attraction of moisture in the air. Non-polar solvents are thus well-suited for the invention. In contrast, polar solvents have a high hygroscopicity and have reactivity and non-compatibility with the binder, and particularly with the lithium metal. Polar solvents like N-methyl 1,2 pyrrolidone (NMP) and gamma-butyrolactone (GBL) should be avoided due to their being highly reactive with lithium leading to run away and potentially catastrophic pyric reactions. Preferably the solvent (or co-solvent) will have sufficient volatility to readily evaporate from the printable lithium composition (e.g., in slurry form) to provide drying of the printable lithium composition (slurry) after application and to provide the electrode material in dry form.

The components of the printable lithium composition may be mixed together as a slurry or paste to have a high concentration of solid. Thus the slurry/paste may be in the form of a concentrate with not all of the solvent necessarily added prior to the time of depositing or applying. In one embodiment, the lithium metal powder should be uniformly suspended in the solvent so that when applied or deposited a substantially uniform distribution of lithium metal powder is deposited or applied. Dry lithium powder may be dispersed such as by agitating or stirring vigorously to apply high sheer forces. The polymer binder and solvents are selected to be compatible with each other and with the lithium metal powder. In general, the binder or solvent should be non-reactive with the lithium metal powder or in amounts so that any reaction is kept to a minimum and violent reactions are avoided.

In another embodiment, a mixture of the polymer binder, rheology modifier, coating reagents, and other potential additives for the lithium metal powder may be formed and introduced to contact the lithium droplets during the dispersion at a temperature above the lithium melting point, or at a lower temperature after the lithium dispersion has cooled such as described in U.S. Pat. No. 7,588,623 the disclosure of which is incorporated by reference in its entirety. The thusly modified lithium metal may be introduced in a crystalline form or in a solution form in a solvent of choice. It is understood that combinations of different process parameters could be used to achieve specific coating and lithium powder characteristics for particular applications.

Conventional pre-lithiation surface treatments require compositions having very low binder content and very high lithium; for example, see U.S. Pat. No. 9,649,688 the disclosure of which is incorporated by reference in its entirety. However, embodiments of the printable lithium composition in accordance with the present invention can accommodate higher binder ratios, including up to 20 percent on dry basis. Various properties of the printable lithium composition, such as viscosity and flow, may be modified by increasing the binder and modifier content up to 50% dry basis without loss of electrochemical activity of lithium. Increasing the binder content facilitates the loading of the printable lithium composition and the flow during printing.

An important aspect of printable lithium compositions is the rheological stability of the suspension. Because lithium metal has a low density of 0.534 g/cc, it is difficult to prevent lithium powder from separating from solvent suspensions. By selection of lithium metal powder loading, polymer binder and conventional modifier types and amounts, viscosity and rheology may be tailored to create the stable suspension of the invention. A preferred embodiment shows no separation at greater than 90 days. This can be achieved by designing compositions with very high zero shear viscosity in the range of 1×10⁴ cps to 1×10⁷ cps. It is however very important to the application process that the compositions, when exposed to shear, exhibit viscosity characteristics in the ranges claimed.

The resulting printable lithium composition preferably may have a viscosity at 10 s⁻¹ about 20 to about 20,000 cps, and often a viscosity of about 100 to about 10,000 cps. At such viscosity, the printable lithium composition is a flowable suspension or gel. The printable lithium composition preferably has an extended shelf life at room temperature and is stable against metallic lithium loss at temperatures up to 60° C., often up to 120° C., and sometimes up to 180° C. The printable lithium composition may separate somewhat over time but can be placed back into suspension by mild agitation and/or application of heat.

In one embodiment, the printable lithium composition comprises on a solution basis about 5 to 50 percent lithium metal powder, about 0.1 to 20 percent polymer binder, about 0.1 to 30 percent rheology modifier and about 50 to 95 percent solvent. In one embodiment, the printable lithium composition comprises on a solution basis about 15 to 25 percent lithium metal powder, about 0.3 to 0.6 percent polymer binder having a molecular weight of 4,700,000, about 0.5 to 0.9 percent rheology modifier, and about 75 to 85 percent solvent. Typically, the printable lithium composition is applied or deposited to a thickness of about 50 microns to 200 microns prior to pressing. After pressing, the thickness can be reduced to between about 1 to 50 microns. Examples of pressing techniques are described, for example, in U.S. Pat. Nos. 3,721,113 and 6,232,014 which are incorporated herein by reference in their entireties.

In one embodiment, the printable lithium composition is deposited or applied to an active anode material on a current collector namely to form a prelithiated anode. Suitable active anode materials include graphite and other carbon-based materials, alloys such as tin/cobalt, tin/cobalt/carbon, silicon-carbon, variety of silicone/tin based composite compounds, germanium-based composites, titanium based composites, elemental silicon, and germanium. The current collector materials may be a foil, mesh or foam and includes using copper, nickel, and the like as the current collector. Application may be via spraying, extruding, coating, printing, painting, and dipping, are described in U.S. application Ser. No. 16/359,723.

In one embodiment, the active anode material and the printable lithium composition are provided together and extruded onto the current collector (e.g., copper, nickel, etc.). For instance, the active anode material and printable lithium composition may be mixed and co-extruded together. Examples of active anode materials include graphite, graphite-SiO, graphite-SnO, SiO, hard carbon and other lithium ion battery and lithium ion capacitor anode materials. In another embodiment, the active anode material and the printable lithium composition are co-extruded to form a layer of the printable lithium composition on the current collector. The deposition of the printable lithium composition including the above extrusion technique may include depositing as wide variety patterns (e.g., dots, stripes), thicknesses, widths, etc. For example, the printable lithium composition and active anode material may be deposited as a series of stripes, such as described in US Publication No. 2014/0186519 incorporated herein by reference in its entirety. The stripes would form a 3D structure that would account for expansion of the active anode material during lithiation. For example, silicon may expand by 300 to 400 percent during lithiation. Such swelling potentially adversely affects the anode and its performance. By depositing the printable lithium as a thin stripe in the Y-plane as an alternating pattern between the silicon anode stripes, the silicon anode material can expand in the X-plane alleviating electrochemical grinding and loss of particle electrical contact. Thus, the printing method can provide a buffer for expansion. In another example, where the printable lithium formulation is used to form the anode, it could be co-extruded in a layered fashion along with the cathode and separator, resulting in a solid-state battery.

In additional embodiments, at least a portion of the printable lithium composition can be supplied to the anode active material prior to assembly of the battery. In other words, the anode can comprise partially lithium-loaded silicon-based active material, in which the partially loaded active material has a selected degree of loading of lithium through intercalation/alloying or the like.

The cathode is formed of an active material, which is typically combined with a carbonaceous material and a binder polymer. The active material used in the cathode is preferably a material that can be lithiated. Preferably, non-lithiated materials such as MnO₂, V₂O₅, MoS₂, metal fluorides or mixtures thereof, sulfur and sulfur composites can be used as the active material. However, lithiated materials such as lithium iron phosphates, LiMn₂O₄ and LiMO₂ wherein M is Ni, Co or Mn that can be further lithiated can also be used. The non-lithiated active materials are preferred because they generally have higher specific capacities, lower cost, and broader choice of cathode materials in this construction that can provide increased energy and power over conventional secondary batteries that include lithiated active materials.

### EXAMPLES

### Example 1

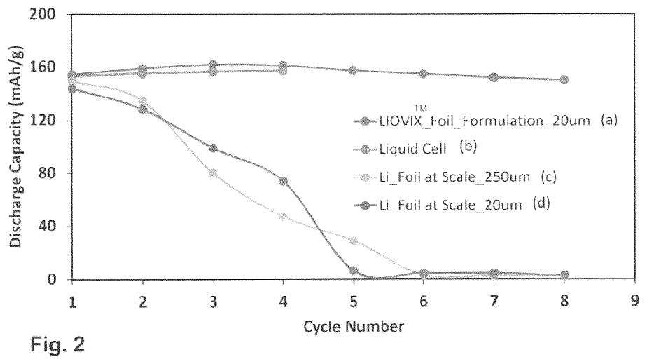

Liovix® printable lithium formulation available from Livent USA Corp. is doctor blade coated on to a copper current collector at a thickness of 20 μm. A coin cell is formed using PEO/LLTZO/LiTSFI as the hybrid solid electrolyte and LiFePO₄ as the cathode. FIG. 2 is a plot showing cycle performance for:
a. 20 μm thick LIOVIX® based foil anode with HSE
b. 250 μm thick commercially available Li foil with liquid electrolyte, solid-state battery described in U.S. Pat. No. 11,264,598
c. 250 μm thick commercially available Li foil anode with HSE
d. 20 μm thick conventionally available Li foil anode with HSE.

The coin cells were cycled at 45° C. between 2.8V and 3.8V, with a constant current constant voltage corresponding to 0.1 C and current cutoff at 0.01 C. FIG. 2 demonstrates that the combination of a printable lithium foil anode and a hybrid solid electrolyte (PEO/LLTZO/LiTSFI) performs better than a conventional foil anode having a conventionally available lithium foil having a 250 μm thickness and a conventionally available lithium foil having a 20 μm anode thickness equivalent to the printed lithium foil.

### Example 2

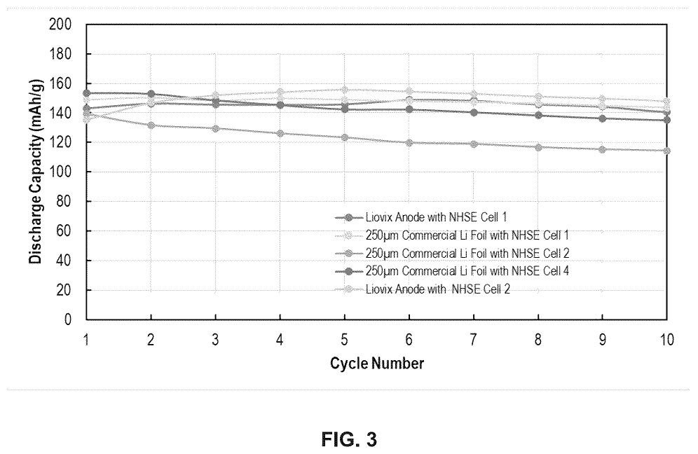

A coin cell is formed using the anode of Example I, LiFePO₄ as the cathode and a hybrid solid electrolyte comprising PEO, LLTZO and Li_{3.25}Zr_{1.75}Sc_{0.25}Si₂PO₁₂ solid electrolyte prepared according to U.S. Ser. No. ______, filed concurrently herewith. The Liovix® printable lithium foil anode has a thickness of 20 μm and with commercial lithium foil anode having a thickness of 250 μm. The coin cells were cycled at 45° C. between 2.8V and 3.8V, with a constant current constant voltage corresponding to 0.1 C and current cutoff at 0.01 C. FIG. 3 demonstrates that the combination of a 20 μm Liovix® printed lithium foil or a conventionally available 250 μm lithium metal anode in combination with the Example 2 solid electrolyte, perform substantially equally.

### Example 3

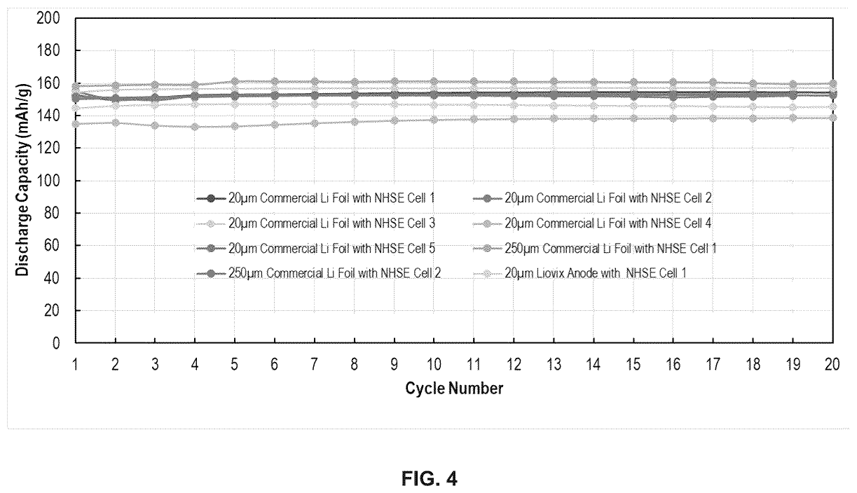

A coin cell is formed using the anode of Example 1, LiFePO₄ as the cathode and a hybrid solid electrolyte comprising PEO, LLTZO and Li_{3.1}Zr_{1.9}Sc_{0.1}Si₂PO₁₂ prepared according to U.S. Ser. No. ______, filed concurrently herewith. The Liovix® printable lithium foil anode has a thickness of 20 μm and with commercial lithium foil anode having a thickness of 20 μm and 250 μm. The coin cells were cycled at 45° C. between 2.8V and 3.8V, with a constant current constant voltage corresponding to 0.1 C and current cutoff at 0.01 C. FIG. 4 demonstrates that the combination of a 20 μm Liovix® printed lithium foil or a conventionally available 20 μm or 250 μm lithium metal anode in combination with the solid electrolyte of Example 3, perform substantially equally.

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

That which is claimed is:

1. A solid-state battery having increased cyclability and increased life, the battery comprising a cathode, an anode and a hybrid solid electrolyte comprising an anode formed by printing a printable lithium composition onto a current collector comprised on a solution basis of a) 5 to 50 percent of lithium metal powder, b) 0.1 to 20 of a polymer binder compatible with the lithium metal powder, and c) 0.1 to 30 percent of a rheology modifier compatible with the lithium metal powder, and d) 50 to 95 percent of a nonpolar solvent compatible with the lithium metal powder and with the polymer binder.

2. The solid-state battery of claim 1, wherein the anode is formed by printing the printable lithium composition onto an anode current collector.

3. The solid-state battery of claim 1, wherein the lithium powder is stabilized lithium metal powder.

4. The solid-state battery of claim 1, wherein the rheology modifier is selected from the group consisting of carbonaceous materials, silicon-containing materials, tin-containing materials, Group IIA oxides, Group IIIA oxides, Group IVB oxides, Group VB oxides and Group VIA oxides.

5. The solid-state battery of claim 1, wherein the hybrid solid electrolyte is PEO/LLTZO/LiTSFI.

6. The solid-state battery of claim 1, wherein the lithium-based hybrid solid electrolyte is Li₃₊ₓ Aₓ B₂₋ₓ Si₂ PO_{12-d} C_{d} wherein A is a trivalent metal, B is a transition metal, C is a halogen or sulfur, x is 0.01 to 0.5, and d is 0 to 12. The trivalent metal may be selected from the group consisting of Sc, Y, La, Cr, Al, Fe, V, Cr, In, Ga, and Lu. The transition metal may be selected from the group consisting of Ti, Ge, Ta, Zr, Sn, Fe, V. Hf, Nb, Sb and As, a polymer solid.

7. The solid-state battery of claim 6, wherein halogen is selected from the group consisting of chlorine, fluorine, bromine, and iodine when d is greater than 0.

8. The solid-state battery of claim 6, wherein the lithium-based solid electrolyte material of the hybrid solid electrolyte is selected from the group consisting of Li_{3.4}Zr_{1.6}Sc_{0.4}Si₂PO₁₂, Li_{3.25}Zr_{1.75}Sc_{0.25}Si₂PO₁₂, Li_{3.4}Zr_{1.6}Sc_{0.4}Si₂PO_{11.95}Cl_{0.05}, Li_{3.4}Zr_{1.6}Sc_{0.4}Si₂PO_{11.9}Cl_{0.1}, Li_{3.25}Zr_{1.75}Sc_{0.25}Si₂PO_{11.95}Cl_{0.05}, and Li_{3.25}Zr_{1.75}Sc_{0.25}Si₂PO_{11.9}Cl_{0.1}, and Li_{3.1}, Zr_{1.9}Sc_{0.1} PO₁₂.

9. A solid-state battery having increased cyclability and increased life, the battery comprising a cathode, and anode and a hybrid solid electrolyte, wherein the anode is formed by depositing a dry electrode mixture comprised of an active component comprising an active electrode material, a binder and a conductive material mixed with a prelithiation printable lithium composition comprising a lithium metal powder, a polymer binder compatible with the lithium metal powder, and a rheology modifier compatible with the lithium metal powder.

10. The solid-state battery of claim 9, wherein the lithium powder is stabilized lithium metal powder.

11. The solid-state battery of claim 9, wherein the rheology modifier is selected from the group consisting of carbonaceous materials, silicon-containing materials, tin-containing materials, Group IIA oxides, Group IIIA oxides, Group IVB oxides, Group VB oxides and Group VIA oxides.

12. The solid-state battery of claim 9, wherein the lithium-based hybrid solid electrolyte is Li₃₊ₓ Aₓ B₂₋ₓ Si₂ PO_{12-d} C_{d} wherein A is a trivalent metal, B is a transition metal, C is a halogen or sulfur, x is 0.01 to 0.5, and d is 0 to 12. The trivalent metal may be selected from the group consisting of Sc, Y, La, Cr, Al, Fe, V, Cr, In, Ga, and Lu. The transition metal may be selected from the group consisting of Ti, Ge, Ta, Zr, Sn, Fe, V. Hf, Nb, Sb and As, a polymer solid.

13. The solid-state battery of claim 12, wherein halogen is selected from the group consisting of chlorine, Fluorine, bromine, and iodine when d is greater than 0.

14. The solid-state battery of claim 12, wherein the lithium-based solid electrolyte material of the hybrid solid electrolyte is selected from the group consisting of Li_{3.4}Zr_{1.6}Sc_{0.4}Si₂PO₁₂, Li_{3.25}Zr_{1.75}Sc_{0.25}Si₂PO₁₂, Li_{3.4}Zr_{1.6}Sc_{0.4}Si₂PO_{11.95}Cl_{0.05}, Li_{3.4}Zr_{1.6}Sc_{0.4}Si₂PO_{11.9}Cl_{0.1}, Li_{3.25}Zr_{1.75}Sc_{0.25}Si₂PO_{11.95}Cl_{0.05}, and Li_{3.25}Zr_{1.75}Sc_{0.25}Si₂PO_{11.9}Cl_{0.1}, and Li_{3.1}, Zr_{1.9}Sc_{0.1}PO₁₂.
